(19) United States
(12) Patent Application Publication
(10) Pub. No.: US 2022/0386035 A1
(43) Pub. Date: Dec. 1, 2022

(54) SPEAKER COMPRISING SPLIT GAP PLATE STRUCTURE

(71) Applicant: Resonado, Inc., Chicago, IL (US)

(72) Inventor: Benny Lee DANOVI, Jackson, MI (US)

(21) Appl. No.: 17/826,758

(22) Filed: May 27, 2022

Related U.S. Application Data
(60) Provisional application No. 63/195,355, filed on Jun. 1, 2021.

(51) Int. Cl. H04R 9/06; H04R 9/04; H04R 9/02; H04R 7/12; H04R 7/18

(52) U.S. Cl. CPC H04R 9/06; H04R 9/043; H04R 9/025; H04R 7/12; H04R 7/18; H04R 2400/11

(57) ABSTRACT

An improved speaker design is disclosed. The top and bottom plates in the speaker each contains a recess. These recesses result in gaps in the magnetic field formed in the top and bottom plates. A voice coil is approximately centered in each magnetic gap. As a voice coil moves in and out of the magnetic gap, the total flux passing through the coil remains constant over a wide range of travel, thereby producing a very linear motor force (BL). Optionally, a Faraday ring or a spacer are placed in the recess between adjacent plates.

### PRIORITY CLAIM

This application claims priority to U.S. Provisional Patent Application No. 63/195,355, filed on Jun. 1, 2021, and titled, “Improved Speaker System,” which is incorporated by reference herein.

### TECHNICAL FIELD

Embodiments are disclosed of a speaker comprising a split gap plate structure, where a physical recess in the plate structure creates a gap in a magnetic field generated by a magnet, resulting in a linear force characteristic for a voice coil operating in the gap.

### BACKGROUND OF THE INVENTION

Prior art speakers typically comprise a set of plates and magnets that generate a magnetic field that interacts with a voice coil. The voice coil receives an electrical audio signal. The current in the voice coil generates a magnetic field that interacts with the magnetic field generated by the plates and magnets, resulting in the voice coil and the structure that holds the voice coil to physically move up or down. This movement in turn creates vibrations in a diaphragm, which results in sound emanating from the speaker.

It is a characteristic of the prior art that the force exerted on the voice coil structure by the magnetic field of the plates and magnets has a non-linear relationship based on the location of the voice coil structure. For example, a certain amount of force may be exerted when the voice coil structure travels one nanometer from its original position, but a different amount of force may be exerted when it travels the next one nanometer distance. This can cause unwanted harmonics in the audio sound, resulting in distortion.

What is needed is an improved speaker design that generates a linear driving force on the voice coil structure to minimize the unwanted harmonics present in prior art speakers.

### SUMMARY OF THE INVENTION

In the embodiments described herein, the top and bottom plates in a speaker motor each contains a recess. These recesses result in gaps in the magnetic field formed in the top and bottom plates. A voice coil is approximately centered in each magnetic gap. As the voice coil moves in and out of a magnetic gap, the total flux passing through the voice coil remains constant over a wide range of travel, thereby producing a very linear motor force (BL). The benefit of this highly linear motor force is that the motor will produce very little harmonic distortion.

Optionally, a Faraday ring is placed in the recess between adjacent plates, further reducing distortion caused by eddy currents and inductance from the voice coil. This Faraday ring may also be used as an assembly aid and structural member of the motor structure, especially in the case where the adjacent plates are not unified.

Optionally, a spacer can be used instead of a Faraday ring.

### BRIEF DESCRIPTION OF THE DRAWINGS

FIG. 1 depicts a motor for use in a speaker.

FIG. 2 depicts magnetic flux density of the motor.

FIG. 3 depicts a graph of motor force versus distance travelled by a voice coil.

FIG. 4 depicts another embodiment of a motor for use in a speaker.

FIGS. 5A, 5B, 5C, 5D, 5E, 5F, and 5G depict a speaker and components thereof.

FIGS. 6A, 6B, 6C, and 6D depict components of a speaker, including Faraday rings.

FIG. 7 depicts components of a speaker, including spacers.

FIG. 8 depicts components of a speaker.

FIG. 9 depicts a single-magnet motor for use in a speaker.

FIG. 10 depicts magnetic flux density of the single-magnet motor of FIG. 9.

### DETAILED DESCRIPTION OF THE PREFERRED EMBODIMENT

Features and advantages of the present invention described above will become apparent from the following descriptions in conjunction with the accompanying drawings. According to the descriptions, a person with the proper technical expertise will be able to execute the technical idea illustrated in this present invention in the relevant industry. Since this invention can have a variety of different applications and may take different forms and shapes, only specific examples are illustrated through Figures and the detailed descriptions are found in the main text. However, this is by no means to restrict the present invention to the particular form disclosed; its derivations, equivalents, and substitutes must be understood as embracing all included in the scope of the present invention. The terms used herein are merely used to describe particular examples and are not intended to limit the present invention.

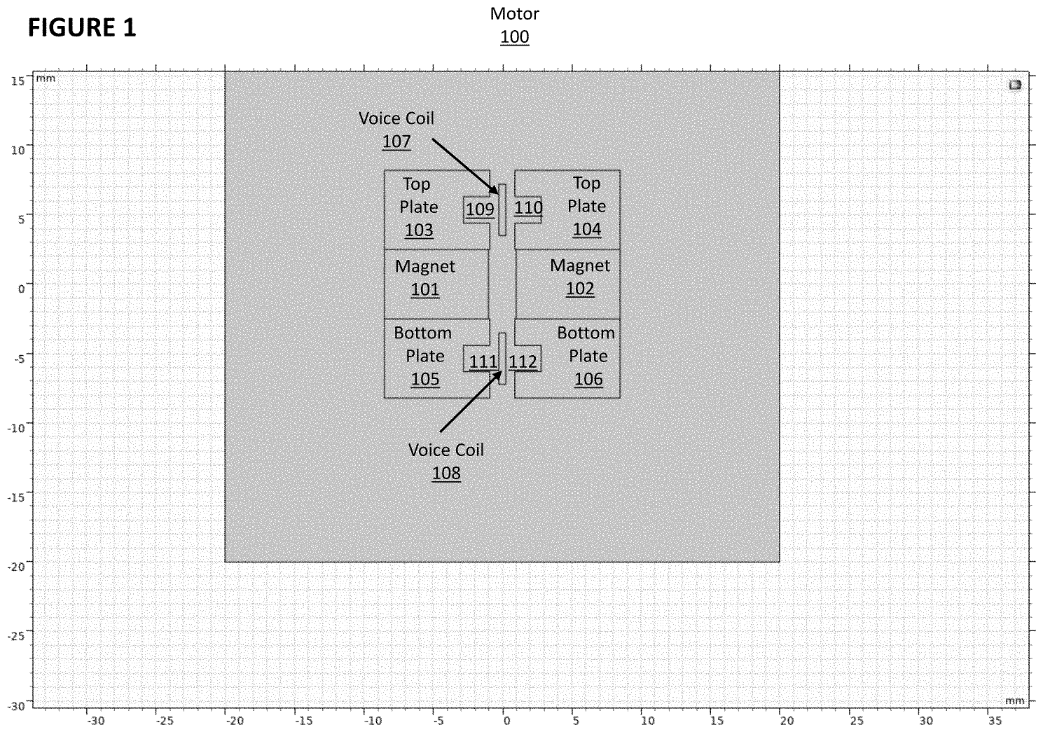

FIG. 1 depicts a side view of a cross-section of motor 100 for use in a speaker. Motor 100 comprises magnets 101 and 102, top plates 103 and 104, bottom plates 105 and 106, and voice coils 107 and 108. Magnets 101 and 102 are permanent magnets. Top plate 103 is attached to the top part of magnet 101 and top plate 104 is attached to the top part of magnet 102. Bottom plate 105 is attached to the bottom part of magnet 101 and bottom plate 106 is attached to the bottom part of magnet 102. Top plate 103 comprises recess 109, top plate 104 comprises recess 110, bottom plate 105 comprises recess 111, and bottom plate 106 comprises recess 112. Top plate 103, magnet 101, and bottom plate 105 can be referred to as a first assembly, and top plate 104, magnet 102, and bottom plate 106 can be referred to as a second assembly.

Voice coils 107 and 108 are attached to a structure (not shown), such as a plate, bobbin, printed circuit board (PCB), or other structure. Each voice coil 107 and 108 receives an electrical audio signal from a signal source (not shown), and current through each voice coil 107 and 108 generates a magnetic field. Voice coils 107 and 108 can receive the same audio signal, different versions of the same audio signal that are 180 degrees out of phase with one another, or different audio signals.

A magnetic field is induced by magnets 101 and 102, generally in the direction from the north poles (N) to the south poles (S). Here, magnets 101 and 102 are oriented in opposite directions, so that the north pole of one magnet is on the top and the north pole of the other magnet is on the bottom. Lorentz forces are generated by the voice coils 107 and 108 interacting with the magnetic field generated by magnet 101 and 102, which pushes the voice coil structure containing voice coils 107 and 108 upward or downward, which pushes a diaphragm (not shown) upward or downward, respectively, according to the magnitude of the electrical signal(s) from the signal source(s).

In one embodiment, the winding height of voice coil 107 and 108 is approximately 65% of that of the gap height for by recesses 109 and 110 and 111 and 112, but it can be taller or shorter. In one embodiment, the recess height and depth are ⅓ of the total height of the voice coil 107 and 108, and placed at the center of the structure at the gap edge. However, these dimensional relationships may also vary.

The opposing plates (such as top plates 103 and 104, and bottom plates 105 and 106) may be unified to be one single plate (e.g., a single top plate or a single bottom plate) connected on the ends beyond the length of magnets 101 and 102. The desired effective plate geometry may be created by stacking multiple plates, one or more of which may be unified with the adjacent plates as described above.

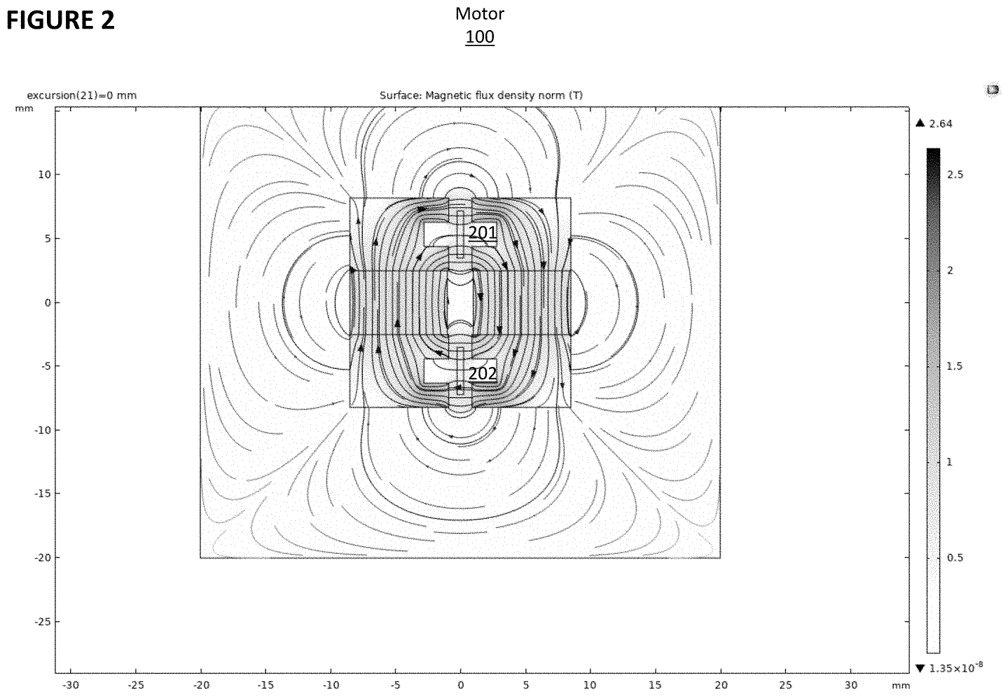

FIG. 2 is a magnetic flux density diagram of motor 100. Recesses 109 and 110 form an upper magnetic gap 201 with a reduced magnetic flux, and recesses 111 and 112 form a lower magnetic gap 202 with a reduced magnetic flux. Recesses 109 and 110 create regions of concentrated magnetic flux above and below upper magnetic gap 201, and recesses 111 and 112 create regions of concentrated magnetic flux above and below lower magnetic gap 202.

Voice coils 107 and 108 are approximately centered in their respective magnetic gaps 201 and 202. As voice coils 107 and 108 move in and out of magnetic gaps 201 and 202, the total flux passing through the voice coil 107 and 108 remains constant over a wide range of travel; therefore producing a very linear motor force (BL). The benefit of this highly linear motor force is that the motor will produce very little harmonic distortion.

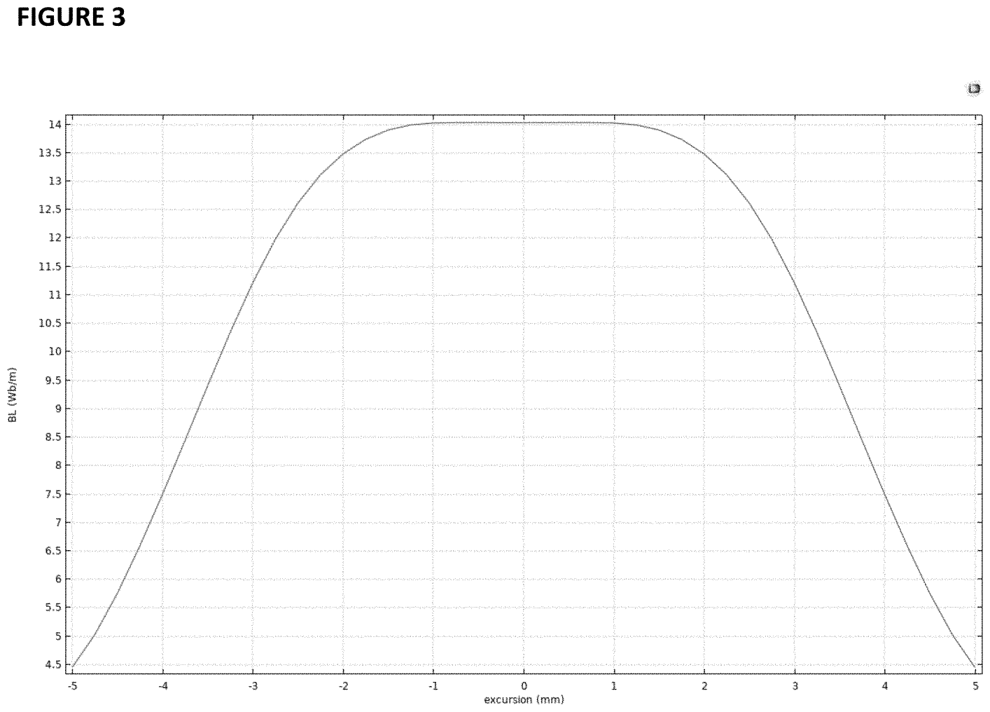

FIG. 3 depicts a graph from a prototype of motor 100. The graph shows motor force (BL) as the excursion of a voice coil 107 or 108 changes relative to its original position in magnetic gap 201 or 202. As can be seen, the motor force is fairly linear for a significant amount of the range of movement of voice coil 107 or 108, as evidenced by the relatively flat slope of the curve between −2 nm and +2 nm.

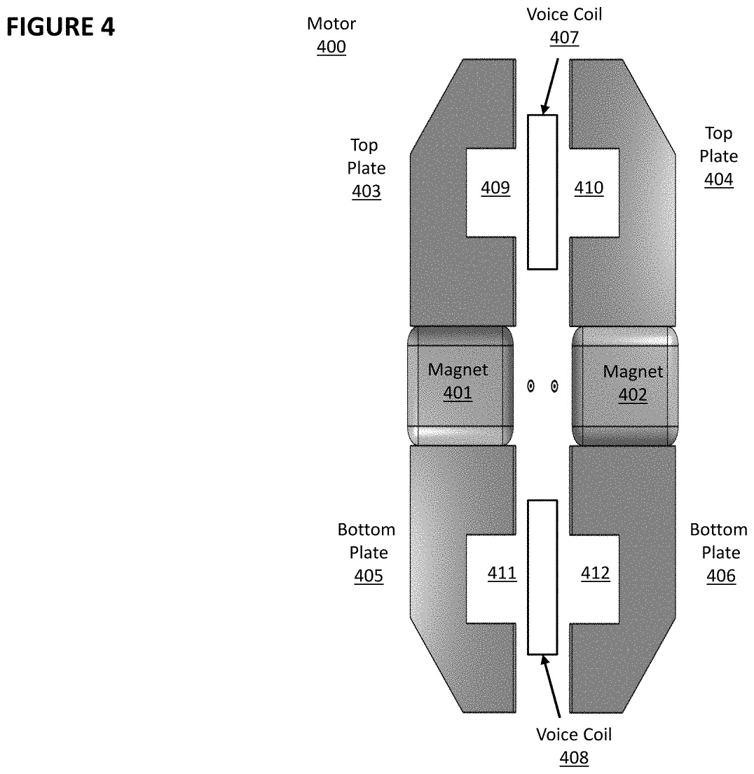

FIG. 4 depicts a side view of a cross-section of motor 400. Motor 400 is functionally similar to motor 100 but contains a different form factor. Motor 400 comprises magnets 401 and 402, top plates 403 and 404, bottom plates 405 and 406, and voice coils 407 and 408. In this example, magnets 401 and 402 are permanent magnets. Top plate 403 is attached to the upper part of magnet 401 and top plate 404 is attached to the upper part of magnet 402. Bottom plate 405 is attached to the lower part of magnet 401 and bottom plate 406 is attached to the lower part of magnet 402. Top plate 403 comprises recess 409, top plate 404 comprises recess 410, bottom plate 405 comprises recess 411, and bottom plate 406 comprises recess 412. Top plate 403, magnet 401, and bottom plate 405 can be referred to as a first assembly, and top plate 404, magnet 402, and bottom plate 406 can be referred to as a second assembly. Motor 400 otherwise operates in the same manner as motor 100 with similar magnetic characteristics.

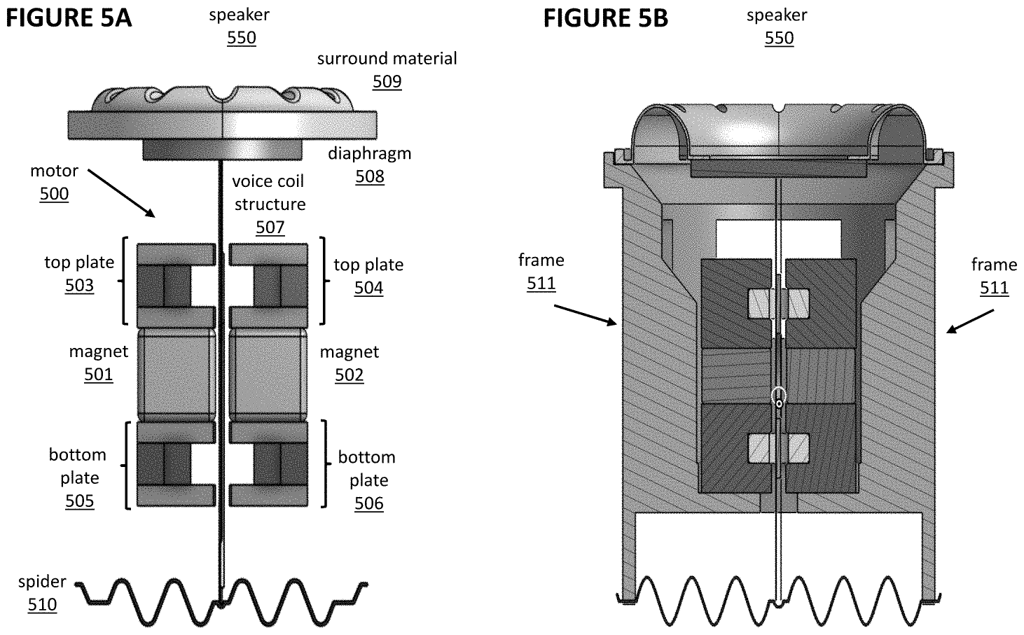

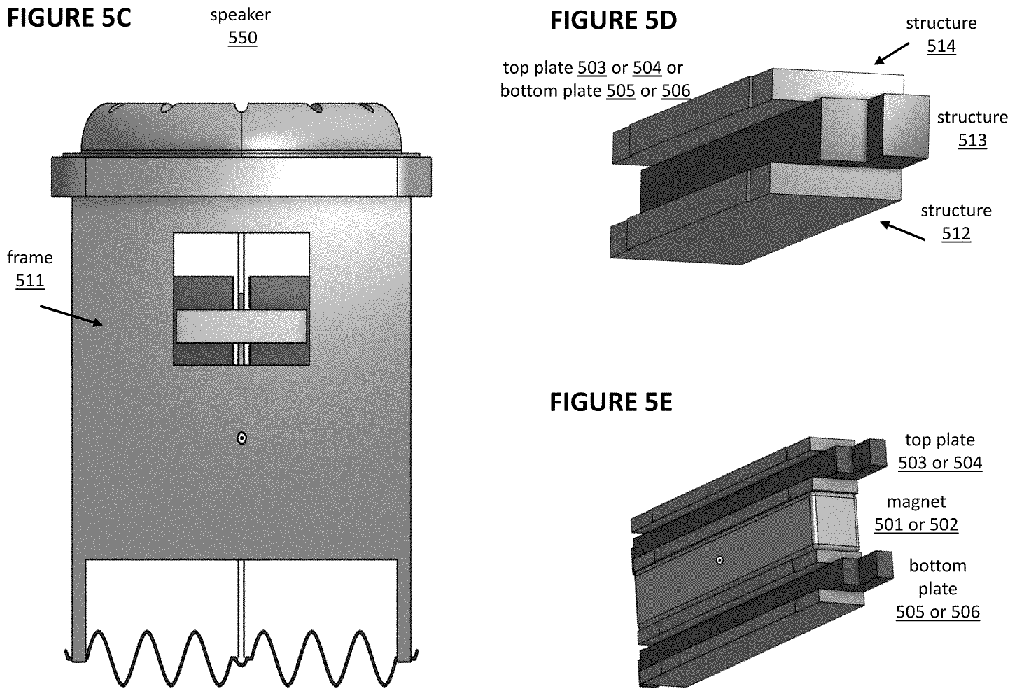

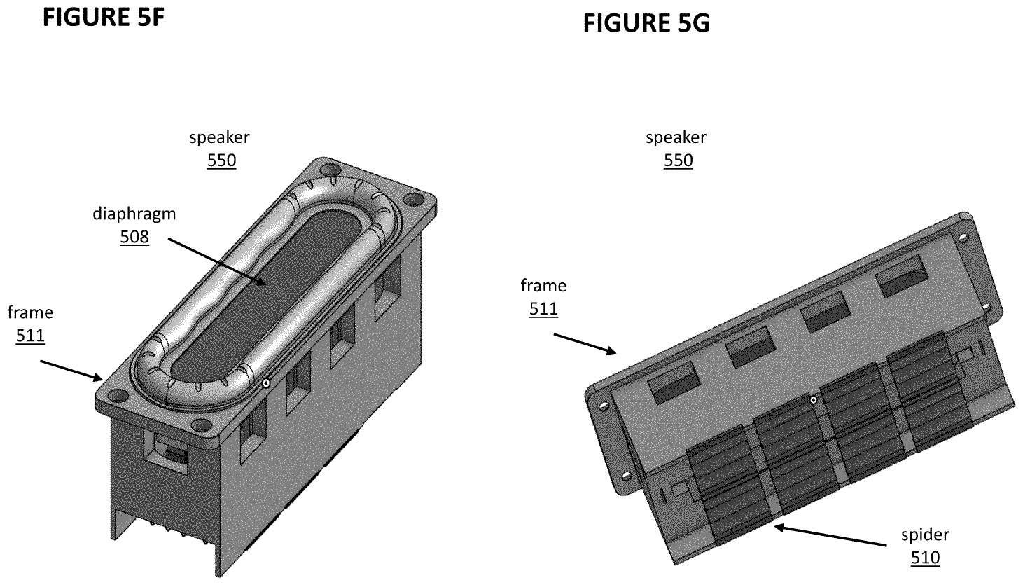

FIG. 5A depicts a cross-section view of speaker 550. Speaker 550 comprises motor 500, diaphragm 508, surround material 509, and spider 510. Motor 500 follows the same principles discussed above for motors 100 and 400. Motor 500 comprises magnets 501 and 502, top plates 503 and 504, bottom plates 505 and 506, and voice coil structure 507. Top plate 503, magnet 501, and bottom plate 505 can be referred to as a first assembly, and top plate 504, magnet 502, and bottom plate 506 can be referred to as a second assembly.

Motor 500 further comprises voice coils (not shown) within the magnetic gaps formed by recesses in the plates. The voice coils are wound around voice coil structure 507, which interacts with diaphragm 508 to generate sound. Diaphragm 508 will be vibrated at a specific frequency range by the magnetic field induced by magnets 501 and 502 and the electric current flowing in the voice coils of voice coil structure 507. Diaphragm 508 is coupled to a frame (not shown) through surround material 509. Surround material 509 comprises a flexible material such as rubber. The other end of voice coil structure 507 is coupled to the frame through spider 510. The voice coils are driver by one or more signal sources (not shown).

Diaphragm 508 must be configured to produce the corresponding frequency range sound accordingly with the size of diaphragm 508. In this embodiment, diaphragm 508 is substantially flat. However, diaphragm 508 instead could be convex or concave, or any shape with respect to the top surface of the frame designed for any application-related acoustic design.

FIG. 5B depicts another cross-section view of speaker 550 with frame 511 added in.

FIG. 5C depicts a side view of speaker 550, where frame 511 is no longer shown in a cross-sectional view.

FIG. 5D depicts a cross section of an embodiment of a plate that can be used for top plates 503 and 504 and bottom plates 505 and 506. The plate comprises a first structure 514, a second structure 512, and a third structure 513.

FIG. 5E depicts a cross section of top plate 503 or 504, magnet 501 or 502, and bottom plate 505 or 506. Here, top plate 503 or 504 and bottom plate 505 or 506 are constructed from the plate of FIG. 5D.

FIG. 5F depicts a top view of speaker 550, where diaphragm 508 and frame 511 can be seen.

FIG. 5G depicts a bottom view of speaker 550, where spider 510 and frame 511 can be seen.

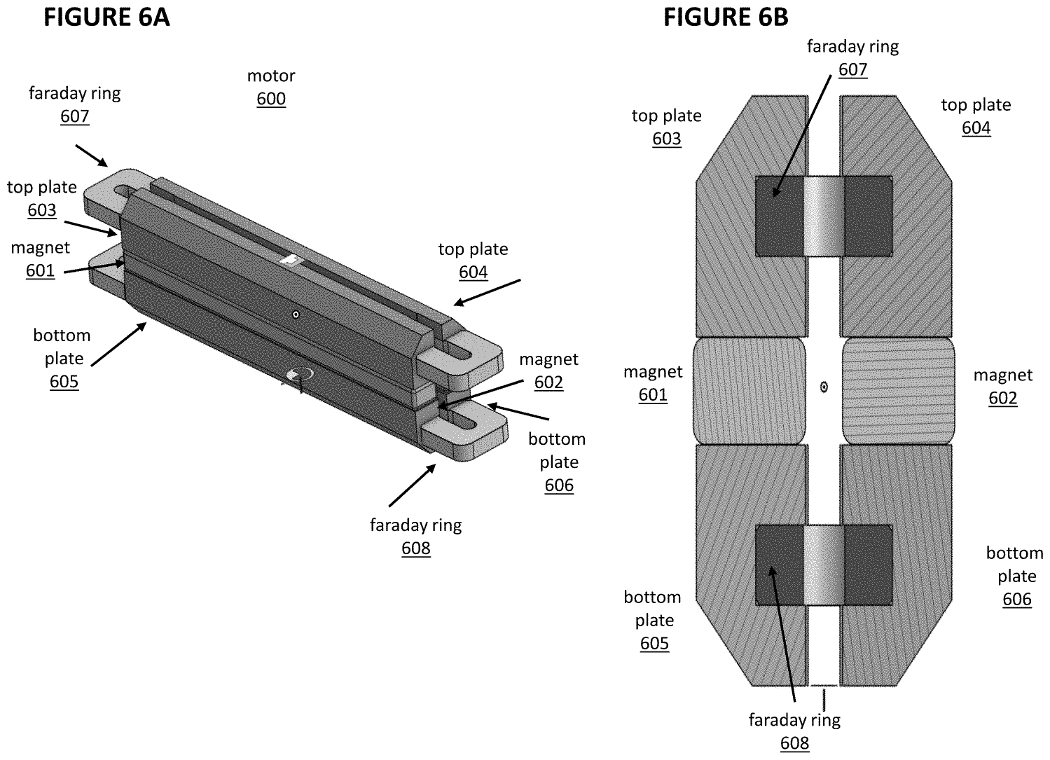

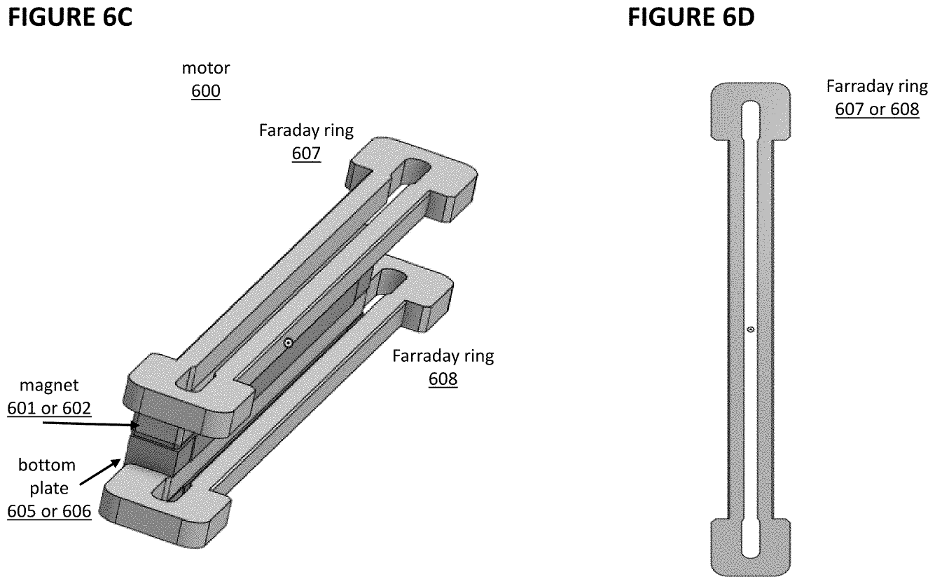

FIGS. 6A, 6B, 6C, and 6D depict an embodiment that utilizes Faraday rings in the magnetic gaps.

FIG. 6A depicts motor 600, which is similar to motors 100, 400, and 500. Motor 600 comprises magnets 601 and 602, top plates 603 and 604, and bottom plates 605 and 606. As with top plates 103 and 104 and bottom plates 105 and 106 in FIG. 1, top plates 603 and 604 and bottom plates 605 and 606 each contain a recess. Top plate 603, magnet 601, and bottom plate 605 can be referred to as a first assembly, and top plate 604, magnet 602, and bottom plate 606 can be referred to as a second assembly.

Faraday ring 607 is placed in the gap formed by recesses in top plates 603 and 604, and Faraday ring 608 is placed in the gap formed by recesses in bottom plates 605 and 606. Faraday rings 607 and 608 will further minimize any magnetic forces in the magnetic gaps formed by the recesses.

Faraday rings 607 and 608 also provide structural support for motor 600 and help maintain a fixed distance between the first assembly comprising top plate 603, magnet 601, and bottom plate 605 and the second assembly comprising top plate 604, magnet 602, and bottom plate 606.

FIG. 6B depicts a cross-section of motor 600, again depicting magnets 601 and 602, top plates 603 and 604, bottom plates 605 and 606, and Faraday rings 607 and 608.

FIG. 6C depicts motor 600 but with certain components removed. Here, magnet 601 or 602 and a portion of bottom plate 605 or 606 are shown in relation to Faraday rings 607 and 608.

FIG. 6D depicts Faraday ring 607 or 608 by itself.

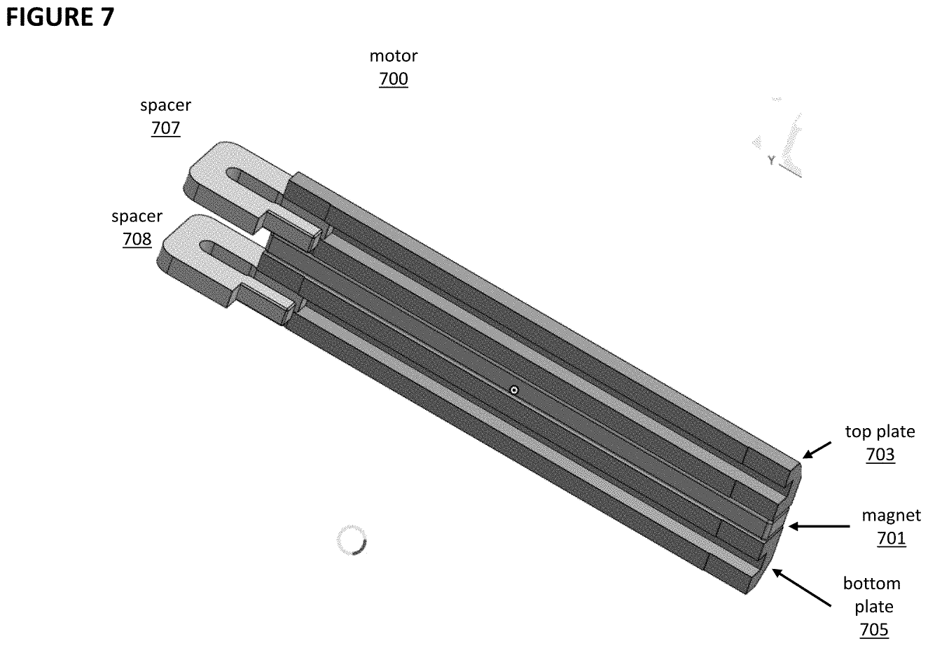

FIG. 7 depicts motor 700, which is similar to motors 100, 400, 500, and 600. Here, only one assembly is shown. The assembly comprises magnet 701, top plate 703, and bottom plate 705. It is to be understood that a counterpart assembly will be used opposite this assembly that will also comprise a magnet, top plate, and bottom plate. As with top plates 103 and 104 and bottom plates 105 and 106 in FIG. 1, top plates 703 and its counterpart and bottom plates 705 and its counterpart each contain a recess. Spacer 707 is placed into the recess formed in top plate 703 and its counterpart and spacer 708 is placed into the recess formed in bottom plate 705 and its counterpart. Spacers 707 and 708 provide structural support for motor 700 and also help maintain a fixed distance between the first assembly comprising top plate 703, magnet 701, and bottom plate 705 and the second assembly comprising counterparts to those components. Spacers 707 and 708 do not affect the magnetic characteristics of motor 700.

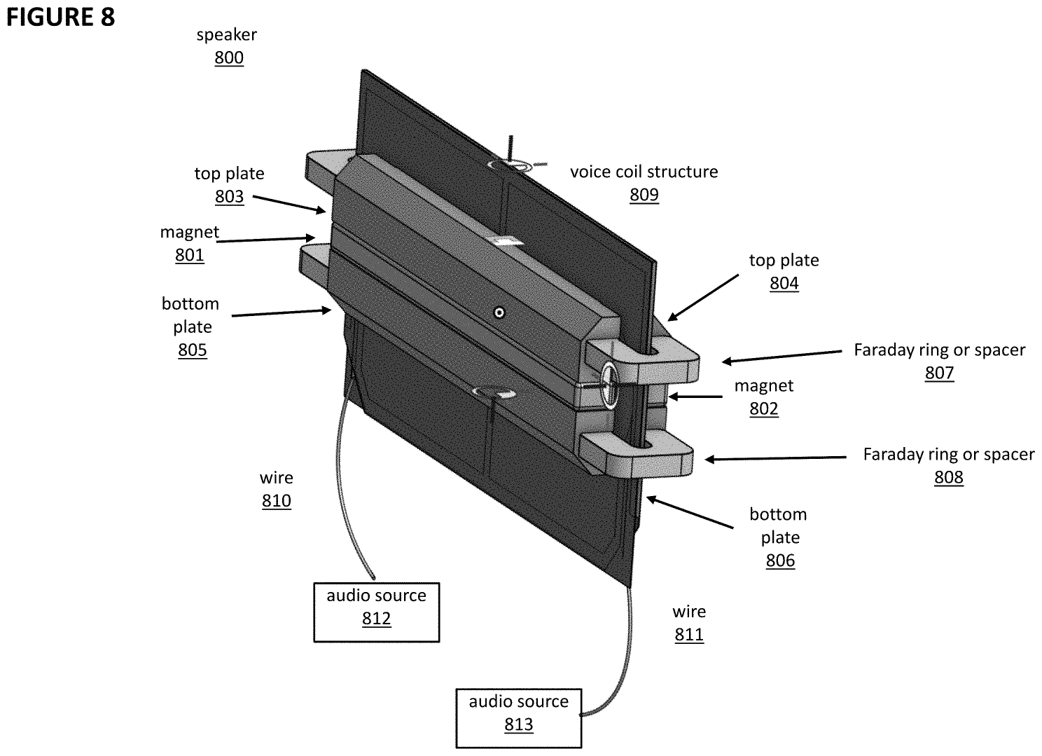

FIG. 8 depicts speaker 800. Speaker 800 comprises magnets 801 and 802, top plates 803 and 804, bottom plates 805 and 806, Faraday rings or spacers 807 and 808, voice coil structure 809, wires 810 and 811, and audio sources 812 and 813. Top plate 803, magnet 801, and bottom plate 805 can be referred to as a first assembly, and top plate 804, magnet 802, and bottom plate 806 can be referred to as a second assembly. Speaker operates according to the same principles described previously for motors 100, 400, 500, and 600.

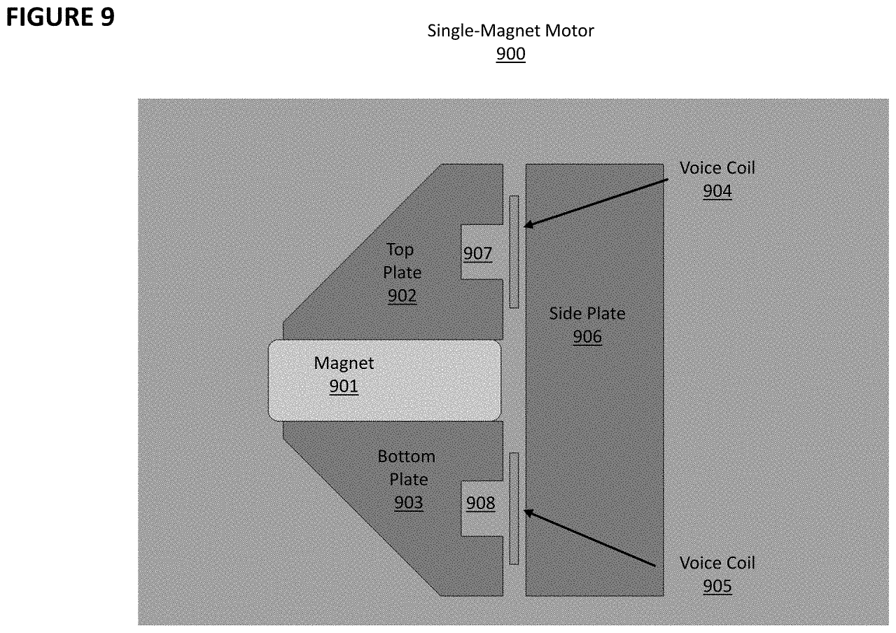

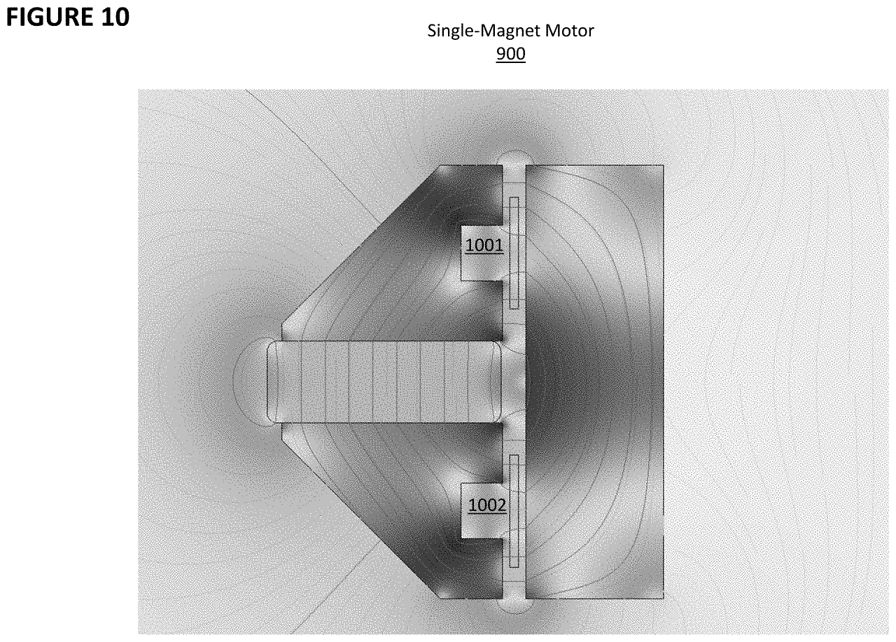

FIGS. 9 and 10 depict single-magnet motor 900, which can be used in a speaker in place of motors 100, 400, 500, or 600 described above. For example, single-magnet motor 900 can be used in speaker 550 in place of motor 500 and can be used in conjunction with diaphragm 508, surround material 509, spider 510, and frame 511 in the same way as described above for motor 500.

FIG. 9 depicts a side view of a cross-section of motor 900 for use in a speaker. Motor 900 comprises magnet 901, top plate 902, bottom plate 903, voice coils 904 and 905, and side plate 906. Magnet 901 is a permanent magnet. Top plate 902 is attached to the top part of magnet 901, bottom plate 903 is attached to the bottom part of magnet 901. Top plate 902 comprises recess 907, and bottom plate 903 comprises recess 908.

Voice coils 904 and 905 are attached to a structure (not shown), such as a plate, bobbin, printed circuit board (PCB), or other structure. Each voice coil 904 and 905 receives an electrical audio signal from a signal source (not shown), and current through each voice coil 904 and 905 generates a magnetic field. Voice coils 904 and 905 can receive the same audio signal, different versions of the same audio signal that are 180 degrees out of phase with one another, or different audio signals.

A magnetic field is induced by magnet 901, generally in the direction from the north pole (N) to the south pole (S). Lorentz forces are generated by the voice coils 904 and 905 interacting with the magnetic field generated by magnet 901, which pushes the voice coil structure containing voice coils 904 and 905 upward or downward, which pushes a diaphragm (not shown) upward or downward, respectively, according to the magnitude of the electrical signal(s) from the signal source(s).

In one embodiment, the winding height of voice coil 904 and 905 is approximately 65% of that of the gap height formed by recesses 907 and 908, but it can be taller or shorter. In one embodiment, the recess height and depth are ⅓ of the height of each of voice coils 904 and 905, and placed at the center of the structure at the gap edge. However, these dimensional relationships may also vary.

Magnet 901, top plate 902, and bottom plate 903 may be referred to as a first assembly, and side plate 906 may be referred to as a second assembly.

FIG. 10 is a magnetic flux density diagram of motor 900. Recess 907 forms an upper magnetic gap 1001 with a reduced magnetic flux, and recess 908 forms a lower magnetic gap 1002 with a reduced magnetic flux. Recess 907 create regions of concentrated magnetic flux above and below upper magnetic gap 1001, and recess 908 creates regions of concentrated magnetic flux above and below lower magnetic gap 1002.

Voice coils 904 and 905 are approximately centered in their respective magnetic gaps 1001 and 1002. As voice coils 904 and 905 move in and out of magnetic gaps 1001 and 1002, the total flux passing through the voice coil 904 and 905 remains constant over a wide range of travel; therefore producing a very linear motor force (BL). The benefit of this highly linear motor force is that the motor will produce very little harmonic distortion.

In all embodiments described herein, each voice coil may be comprised of any electrically-conductive material, including but not limited to, any variant of copper wire, printed circuit board, flexible printed circuit board, or other conductive metal or alloy.

In all embodiments described herein, electric audio signals from one or more signal sources is translated into kinetic energy to move one or more diaphragms, reproducing sound.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures which, although not explicitly shown or described herein, embody the principles of the disclosure and can be thus within the spirit and scope of the disclosure. Various different exemplary embodiments can be used together with one another, as well as interchangeably therewith, as should be understood by those having ordinary skill in the art. In addition, certain terms used in the present disclosure, including the specification, drawings and claims thereof, can be used synonymously in certain instances, including, but not limited to, for example, data and information. It should be understood that, while these words, and/or other words that can be synonymous to one another, can be used synonymously herein, that there can be instances when such words can be intended to not be used synonymously. Further, to the extent that the prior art knowledge has not been explicitly incorporated by reference herein above, it is explicitly incorporated herein in its entirety. All publications referenced are incorporated herein by reference in their entireties.

What is claimed is:

1. A speaker comprising:
a first assembly comprising a first magnet comprising a first side and a second side, a first top plate adjacent to the first side of the first magnet and comprising a recess, and a first bottom plate adjacent to the second side of the first magnet and comprising a recess;
a second assembly comprising a second magnet comprising a first side and a second side, a second top plate adjacent to the first side of the second magnet and comprising a recess, and a second bottom plate adjacent to the second side of the second magnet and comprising a recess;
a first magnetic gap formed by the recess of the first top plate and the recess of the second top plate;
a second magnetic gap formed by the recess of the first bottom plate and the recess of the second bottom plate; and
a voice coil structure comprising a first voice coil centered in the first magnetic gap and a second voice coil centered in the second magnetic gap.

2. The speaker of claim 1, further comprising:
a diaphragm attached to a first end of the voice coil structure.

3. The speaker of claim 2, wherein the voice coil structure vibrates the diaphragm in response to force generated by an electrical signal in the first voice coil and the second voice coil and a magnetic field generated by the first magnet and the second magnet.

4. The speaker of claim 2, wherein the voice coil structure vibrates the diaphragm in response to force generated by a first electrical signal in the first voice coil and a second electrical signal in the second voice coil and a magnetic field generated by the first magnet and the second magnet.

5. The speaker of claim 2, further comprising a frame.

6. The speaker of claim 5, wherein the diaphragm is connected to the frame by a surround material.

7. The speaker of claim 1, further comprising a first Faraday ring arranged in the recess of the first top plate and the recess of the second top plate.

8. The speaker of claim 7, further comprising a second Faraday ring arranged in the recess of the first bottom plate and the recess of the second bottom plate.

9. The speaker of claim 1, further comprising a first spacer arranged in the recess of the first top plate and the recess of the second top plate.

10. The speaker of claim 9, further comprising a second spacer arranged in the recess of the first bottom plate and the recess of the second bottom plate.

11. The speaker of claim 1, wherein the first top plate comprises a single structure and the second top plate comprises a single structure.

12. The speaker of claim 11, wherein the first bottom plate comprises a single structure and the second bottom plate comprises a single structure.

13. The speaker of claim 1, wherein the first top plate comprises a plurality of structures and the second top plate comprises a plurality of structures.

14. The speaker of claim 13, wherein the first bottom plate comprises a plurality of structures and the second bottom plate comprises a plurality of structures.

15. A motor comprising:
a first assembly comprising a first magnet comprising a first side and a second side, a first top plate adjacent to the first side of the first magnet and comprising a recess, and a first bottom plate adjacent to the second side of the first magnet and comprising a recess;
a second assembly comprising a second magnet comprising a first side and a second side, a second top plate adjacent to the first side of the second magnet and comprising a recess, and a second bottom plate adjacent to the second side of the second magnet and comprising a recess;
a first magnetic gap formed by the recess of the first top plate and the recess of the second top plate;
a second magnetic gap formed by the recess of the first bottom plate and the recess of the second bottom plate; and
a voice coil structure comprising a first voice coil centered in the first magnetic gap and a second voice coil centered in the second magnetic gap.

16. The motor of claim 15, further comprising a first Faraday ring arranged in the recess of the first top plate and the recess of the second top plate.

17. The motor of claim 16, further comprising a second Faraday ring arranged in the recess of the first bottom plate and the recess of the second bottom plate.

18. The motor of claim 15, further comprising a first spacer arranged in the recess of the first top plate and the recess of the second top plate.

19. The motor of claim 18, further comprising a second spacer arranged in the recess of the first bottom plate and the recess of the second bottom plate.

20. The motor of claim 15, wherein the first top plate comprises a single structure and the second top plate comprises a single structure.

21. The motor of claim 20, wherein the first bottom plate comprises a single structure and the second bottom plate comprises a single structure.

22. The motor of claim 15, wherein the first top plate comprises a plurality of structures and the second top plate comprises a plurality of structures.

23. The motor of claim 22, wherein the first bottom plate comprises a plurality of structures and the second bottom plate comprises a plurality of structures.

24. A speaker comprising:
a first assembly comprising a magnet comprising a first side and a second side, a top plate adjacent to the first side of the magnet and comprising a first recess, and a bottom plate adjacent to the second side of the magnet and comprising a second recess;
a second assembly comprising a side structure;
a first magnetic gap formed by the first recess;
a second magnetic gap formed by the second recess; and
a voice coil structure comprising a first voice coil centered in the first magnetic gap between the top plate and the side structure and a second voice coil centered in the second magnetic gap between the bottom plate and the side structure.

25. The speaker of claim 24, further comprising:
a diaphragm attached to a first end of the voice coil structure.

26. The speaker of claim 25, wherein the voice coil structure vibrates the diaphragm in response to force generated by an electrical signal in the first voice coil and the second voice coil and a magnetic field generated by the first magnet and the second magnet.

27. The speaker of claim 25, wherein the voice coil structure vibrates the diaphragm in response to force generated by a first electrical signal in the first voice coil and a second electrical signal in the second voice coil and a magnetic field generated by the magnet.

28. The speaker of claim 25, further comprising a frame.

29. The speaker of claim 28, wherein the diaphragm is connected to the frame by a surround material.
